(19) United States
(12) Patent Application Publication
(10) Pub. No.: US 2007/0115928 A1
(43) Pub. Date: May 24, 2007

(54) Network support for enhanced VoIP caller ID

(76) Inventors: David S. Benco, Winfield, IL (US); Sanjeev Mahajan, Naperville, IL (US); Baoling S. Sheen, Naperville, IL (US); Sandra L. True, St. Charles, IL (US)

Correspondence Address: CARMEN B. PATTI & ASSOCIATES, LLC, ONE NORTH LASALLE STREET, 44TH FLOOR, CHICAGO, IL, 60602, US

(21) Appl. No.: 11/268,921

(22) Filed: Nov. 8, 2005

(51) Int. Cl. H04L 12/66; H04M 7/00

(52) U.S. Cl. 370/352; 379/230

(57) ABSTRACT

An apparatus in one example has: a calling terminal and a called terminal in a telecommunication system; at least one of a specified name or a preferred call back number that are input at the calling terminal before originating a call to the called terminal; at least one telecommunication system that operatively couples the calling terminal to the called terminal; and the specified name and/or the preferred call back number being calling party information at the called terminal for the call from the calling party.

### TECHNICAL FIELD

The invention relates generally to telecommunications networks, and more particularly to a telecommunications network that has a caller ID (caller identification) feature.

### BACKGROUND

Wireless and wired communication systems are constantly evolving. System designers are continually developing greater numbers of features for both service providers as well as for the end users. In the area of wireless phone systems, cellular based phone systems have advanced tremendously in recent years. Wireless phone systems are available based on a variety of modulation techniques and are capable of using a number of allocated frequency bands. Available modulation schemes include analog FM and digital modulation schemes using Time Division Multiple Access (TDMA) or Code Division Multiple Access (CDMA). Each scheme has inherent advantages and disadvantages relating to system architecture, frequency reuse, and communications quality. However, the features the manufacturer offers to the service provider and which the service provider offers to the consumer are similar between the different wireless systems.

Regardless of the modulation scheme in use, the wireless phone available to the end user has a number of important features. Nearly all wireless phones incorporate at least a keyboard for entering numbers and text, and a display that allows the user to display text, dialed numbers, pictures and incoming caller numbers. Additionally, wireless phones may incorporate electronic phonebooks, speed dialing, single button voicemail access, and messaging capabilities, such as e-mail.

A particularly useful feature provides caller ID in wireless telecommunication systems, as well as, wired telecommunication systems. Caller ID is a network service feature that permits the recipient of an incoming call to determine, even before answering, the number from which the incoming call is being placed.

In addition to the known wired and wireless telecommunication systems, there is now also Internet telephony. Internet telephony is a category of hardware and software that enables people to use the Internet as the transmission medium for telephone calls. For users who have free, or fixed-price Internet access, Internet telephony software essentially provides inexpensive telephone calls anywhere in the world. Internet telephony products are sometimes called IP (Internet Protocol) telephony, Voice over the Internet (VOI) or Voice over IP (VoIP) products. VoIP or Voice over Internet Protocol is a process of sending voice telephone signals over the Internet or other data networks. If the telephone signal is in analog form (voice or fax), the signal is first converted to a digital form. Packet routing information is then added to the digital voice signal so it can be routed through the Internet or other data network.

Presently, telecommunication systems have many problems in displaying calling party information when the call passes through a VoIP network. Thus, there is a need in the art to provide caller ID features that operate in the Internet telephony environment.

### SUMMARY

One implementation encompasses an apparatus. This apparatus may comprise: a calling terminal and a called terminal in a telecommunication system; at least one of a specified name or a preferred call back number that are input at the calling terminal before originating a call to the called terminal; at least one telecommunication system that operatively couples the calling terminal to the called terminal; and the specified name and/or the preferred call back number being calling party information at the called terminal for the call from the calling party.

Another implementation encompasses an apparatus. This apparatus may comprise: a calling terminal that originates a VoIP call to a called terminal in a telecommunication system; at least one of a specified name or a preferred call back number that are input at the calling terminal before originating the VoIP call to the called terminal; the at least one telecommunication system operatively coupling the calling terminal to the called terminal, the telecommunication system having a data network and at least one of a PTSN (public switched telephone network) or a cellular network; and the specified name and/or the preferred call back number being calling party information at the called terminal for the VoIP call from the calling party.

One implementation encompasses a method. This embodiment of the method may comprise: specifying, at a calling terminal, at least one of a caller name or a preferred call back number before originating a call to a called terminal in a telecommunication system; originating the call and routing the call to the called terminal; and providing the name and preferred call back number as calling party information at the called terminal.

Another implementation encompasses a method. This embodiment of the method may comprise: specifying, before originating a call to a called terminal in a telecommunication system, at least one of a specified caller name or a preferred call back number that is different than a default call back number for a calling terminal; and providing the specified caller name and preferred call back number as calling party information at a called terminal.

### DESCRIPTION OF THE DRAWINGS

Features of exemplary implementations of the invention will become apparent from the description, the claims, and the accompanying drawings in which:

FIG. 1 is a representation of one implementation of an apparatus in which a telecommunications network that has a caller ID feature;

FIG. 2 is a representation of one exemplary flow diagram for providing a caller ID feature functionality in a telecommunications network; and

FIG. 3 is a representation of another exemplary flow diagram for providing a caller ID feature functionality in a telecommunications network.

### DETAILED DESCRIPTION

One methology of the present method and apparatus is for the caller to specify a name and preferred call back number before the caller originates the VoIP call or a PSTN public call office call. Another methology of the present method and apparatus is for the network to route the specified caller name and preferred call back number over VoIP and PSTN networks. A further methology of the present method and apparatus is for presentation of the specified caller name and preferred call back number to the called party. Embodiments of the present method and apparatus may be used with various networks, such as a PTSN networks, a data networks, a cellular networks, and combinations of such networks. Embodiments of the present method and apparatus are especially useful with calls placed over the Internet.

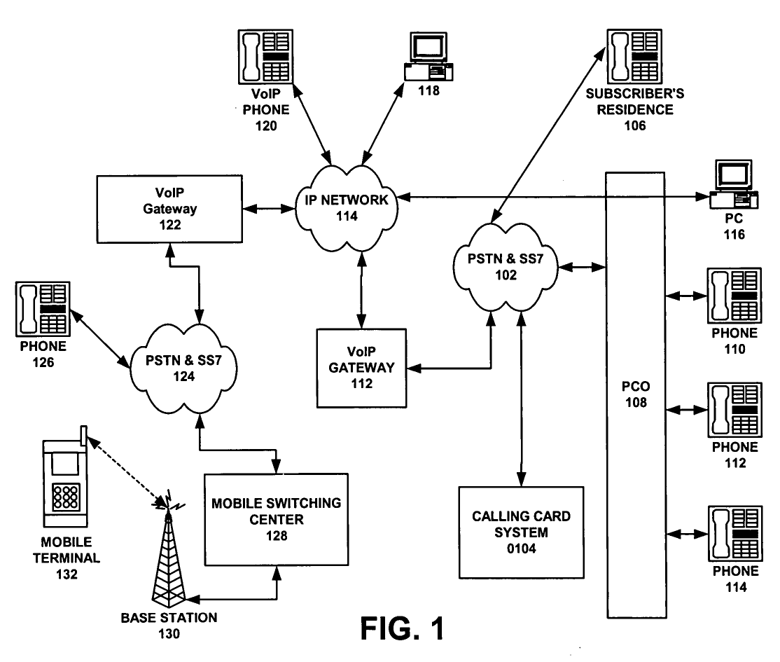

FIG. 1 is a representation of one implementation of an apparatus in which a telecommunications network that has a caller ID feature according to the present method and apparatus. VoIP is the transmission of a telephone call over the Internet, such as IP network 114. The Internet sends small packets of data over a network by packet switching. At the source, a large amount of data is split it up into many packets. Each packet is given an address that tells the network where to route each packet. At the destination, the packets are reassembled into the original data. Packet switching is very efficient because it minimizes the amount of time that a connection must be maintained between two sources and thus reduces the load on a network.

For IP Telephony or VoIP, once a session is initiated the analog voice signal from the speaker is converted into digital format, the signal is compressed into IP packets that are transmitted over the Internet. At the receiving end, the signal is decompressed from packets into a digital signal which is then converted into an analog signal for the listener. A VoIP call can occur under various scenarios. In order for a call to take place, a user must have access to necessary components including a broadband transmission standard, a gateway, and in some instances an adapter.

There are several different VoIP Scenarios, including computer to computer, computer to phone, phone to computer and phone to phone. While the calls follow the same basic format, there are a few differences in transmission depending upon the source and destination of the voice data.

A call made from one computer to another computer, for example PC (personal computer) 116 and PC 118, requires each computer user to have the same software, a microphone, speakers, a sound card, and a high-speed internet connection. When a call is made from a computer, no gateways are involved. The VoIP software will map to the recipient's computer and initiate the session. Two channels will be implemented between the computers, one for each direction, as part of the session. This means that each computer knows to expect packets of data from the other computer.

When the call is placed thru the computer, the computer digitizes the analog voice signal, compresses it into packets and sends it over the Internet to the recipient's computer. The recipient's computer organizes the packets and decompresses them into the original data for the recipient to hear. The same occurs from the recipient to the caller. When the conversation is finished, the caller's computer will send a signal to the recipient's computer that terminates the session.

There is no charge for a long distance call made from one computer to another; however, there is probably a monthly ISP (Internet Service Provider) fee for connection to the Internet.

A call placed from a computer to a telephone, for example PC 118 and subscriber's residence phone 106, requires the computer user to have the requisite software, a microphone, speakers, a sound card, and a high speed Internet connection. The computer software will map to the gateway, such as VoIP gateway 112 closest to the recipient's PSTN, such as PSTN and SS7 102. Once a session is established, two channels are implemented between the computer 118 and the gateway 112. This means that the computer 118 and the gateway 112 know to expect packets of data from each other. There will also be an open circuit on the PSTN 102 between the gateway 112 and the recipient 106.

When the call is placed thru the computer 118, the computer 118 digitizes the analog voice signal, compresses it into packets and sends it over the Internet 114 to the gateway 112. The gateway 112 organizes the packets and decompresses them into the original data to be delivered to the recipient 106. When data comes from the recipient 106, the gateway 112 digitizes the analog voice signal, compresses it into IP packets, and moves it onto the Internet 114 for transport to the caller's computer 118. When the packets are received by the computer 118, the packets are put in order and decompressed into the original data.

When the conversation is finished, the caller's computer 118 will send a signal to the gateway 112 that terminates the session. The gateway 112 will then close the circuit between it and the recipient 106. The recipient 106 is now free to accept other calls. Once the session is terminated, the gateway 112 removes the gateway-to-computer mapping from its memory.

This type of call may have a small per-minute charge incurred by the connection between the gateway 112 and recipient 106 and costs charged by the gateway 112, but will be much cheaper than a traditional long-distance call. For cost savings, the PSTN 102 used is located as near to the recipient 106 as possible to minimize the price for the gateway-to-recipient connection. Also, there is probably a monthly ISP fee for connection to the Internet 114.

A call made from a phone, such as subscriber's residence phone 106 and a computer, such as PC 118 will only work if the caller first dials into a gateway, such as gateway 112, and if the computer user has the requisite software, a microphone, speakers, a sound card, and a high speed Internet connection. After the caller 106 is connected to the gateway 112, the number of the receiving party 118 is dialed. This number is temporarily stored by the gateway 112. The gateway 112 checks the format of the number entered and then determines whom to map the number to. In mapping, the number is attached to the IP address of the recipient's computer 118. Once a session is established, two channels are implemented between the gateway 112 and the computer 118. This means that the gateway 112 and the computer 118 know to expect packets of data from each other. There will also be an open circuit on the PSTN 102 between the caller 106 and the gateway 112.

When a call is placed thru the gateway 112 to the recipient 118, the gateway 112 digitizes the analog voice signal, compresses it into IP packets, and moves it onto the Internet 114 for transport to the computer 118 at the receiving end. When the packets are received by the computer 118, the packets are put in order and decompressed into the original data. When data comes from the recipient 118, the computer 118 digitizes the analog voice signal, compresses it into packets and sends it over the Internet 114 to the gateway 112. The gateway 112 organizes the packets and decompresses them into the original data to be delivered to the caller 106.

When the caller is finish talking and hangs up the phone 106, the circuit is closed between the caller 106 and the caller's gateway 112. Once this circuit is closed the caller's phone line is free to accept other calls. The gateway 112 then sends a signal to the recipient's computer 118 that terminates the session. Once the session is terminated, the gateway 112 removes the gateway-to-computer mapping from its memory.

This type of call will only entail local call costs incurred by the connection to the gateway 112 and costs charged by the gateway 112. The computer user will probably have a monthly ISP fee for connection to the Internet 114.

VoIP is used to route traffic that may be originated from and terminated at conventional PSTN telephones. A call from one telephone 106 to another telephone 126 starts with a connection to a gateway 112. A special number will have to be dialed first to reach the gateway 112 before dialing the number of the person or place the caller wishes to reach. After connection to the gateway 112, the caller 106 dials the number of the party he or she wishes to talk to and the number is temporarily stored by the gateway 112. The gateway 112 checks the format of the number entered and then determines whom to map the number to. In mapping, the number is attached to the IP address of another gateway 122. This other gateway 122 is connected directly to or as close as possible to the PSTN 124 of the number dialed. Two channels will be implemented between the gateways 112 and 122, one for each direction, as part of the session. This means that each gateway knows to expect packets of data from the other gateway.

When the call is placed thru the gateway 112 to the recipient 126, the gateway 112 digitizes the analog voice signal, compresses it into IP packets, and moves it onto the Internet 114 for transport to the gateway 122 at the receiving end. When the packets are received by the gateway 122, the packets are put in order and decompressed into the original data and delivered to the recipient 126. The same occurs from the recipient 126 to the caller 106. The gateway 112 at the caller's end 106 keeps the circuit open between itself and the caller 106. The gateway 122 at the recipient's end 126 keeps the circuit open between itself and the recipient 126. These open circuits are PSTN, such as PSTN 102 and 124, connections to the gateways 112 and 122.

When the caller 106 is finish talking and hangs up the phone, the circuit is closed between the caller 106 and the caller's gateway 112. Once this circuit is closed the caller's phone line is free to accept other calls. The gateway 112 then sends a signal to the recipient's gateway 122 that terminates the session. The gateway 122 at the recipient's end closes the circuit between it and the recipient 126. The recipient 126 is now also free to accept other calls. Once the session is terminated, the gateways 112 and 122 remove the number-to-gateway mapping from memory.

Rates for VoIP calls between telephones are much lower than traditional long distance calls. The only costs associated with VoIP calls made between two telephones are local call costs incurred in reaching the gateway and whatever costs are charged by the gateway operators. The gateway on the recipient's end will charge more or less depending on the distance of the connection between the gateway and the phone system of the recipient.

Calls from other devices may be handled in a similar manner. For example, calls may originate or be received by subscriber's mobile phone 132 that connects to the PSTN 124 via a base station 130 and mobile switching center 128. Calls may also originate from pay phones 100, 112, 114 through a public call office (PCO) 108 that is coupled to the PSTN 102. Phones that are VoIP phones may be directly coupled with the Internet or IP network 114.

A calling card system 104 may be connected to the PSTN 102. A calling card or phone card may be a prepaid card or a credit card that can be used to pay for telephone calls. A virtual calling card is also known and is typically an online service that immediately provides you with an access code, but no actual calling card similar to ticket-less billing. Correspondingly, a calling card call is a call for which charges are billed, not to the originating telephone number, but to the telephone calling card issued by a local exchange or long distance telephone company for this purpose.

In general a calling card is a pre-paid service phone with no monthly fee. With a calling card any phone be used, even public phone, anywhere to originate a call. Each calling card has a number called PIN number that is needed in order to use the service. A PIN is the personal identification number designated for that particular phone card.

An access number is a phone number that is dialed to enter the calling card system. In the United States it is generally an 800 toll free number that places a user on the calling card network and allows the user to make cost effective calls. Generally the access number is found on the back of the phone card.

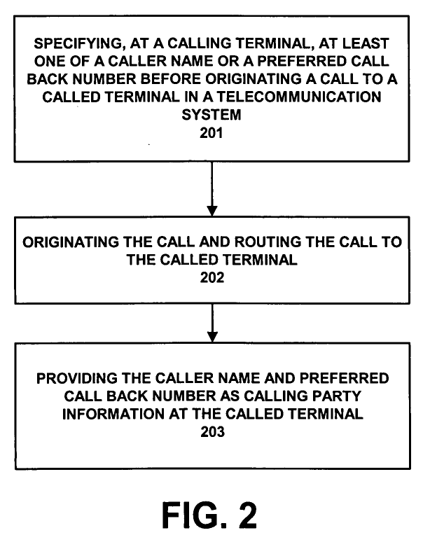

FIG. 2 is a representation of one exemplary flow diagram for providing a caller ID feature functionality in a telecommunications network. This embodiment of the method may comprise: specifying, at a calling terminal, at least one of a caller name or a preferred call back number before originating a call to a called terminal in a telecommunication system (201); originating the call and routing the call to the called terminal (202); and providing the name and preferred call back number as calling party information at the called terminal (203).

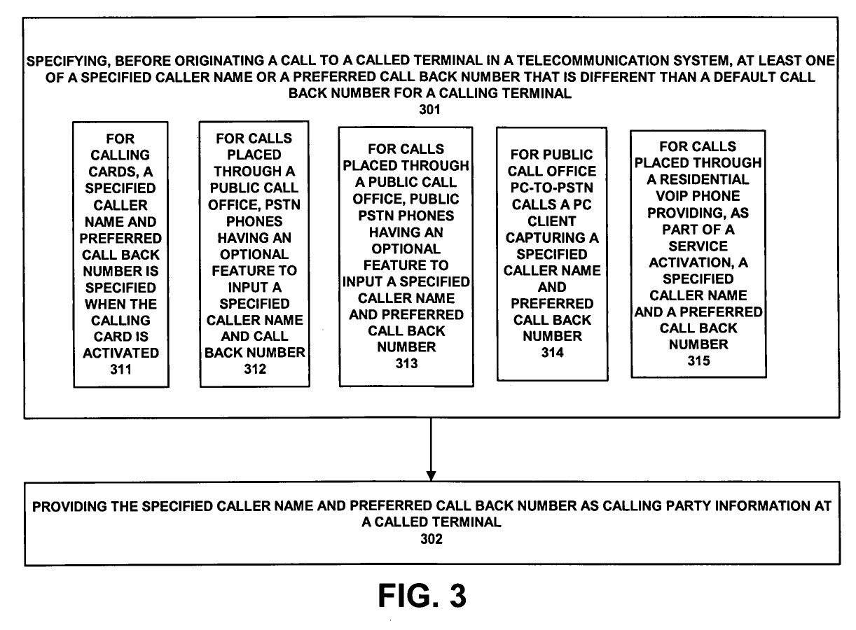

FIG. 3 is a representation of another exemplary flow diagram for providing a caller ID feature functionality in a telecommunications network. This embodiment of the method may comprise: specifying, before originating a call to a called terminal in a telecommunication system, at least one of a specified caller name or a preferred call back number that is different than a default call back number for a calling terminal (301); and providing the specified caller name and preferred call back number as calling party information at a called terminal (302). In particular: for calling cards, a specified caller name and preferred call back number is specified when the calling card is activated (311); for calls placed through a public call office, PSTN phones having an optional feature to input a specified caller name and call back number before the call is originated (312); for calls placed through a public call office, public PSTN phones having an optional feature to input a specified caller name and preferred call back number before the call is originated (313); for public call office PC-to-PSTN calls a PC client capturing a specified caller name and preferred call back number before the call is originated (314); and for calls placed through a residential VoIP phone providing, as part of a service activation, a specified caller name and a preferred call back number (315).

Regarding the IP network, the IP network may route the caller name and the call back number using a new message in the signaling protocol, such as SIP (Session Initiation Protocol), H.323, etc. Once this message arrives at the VoIP gateway, the VoIP gateway may use this information to populate the PSTN calling party information instead of putting in its own information. SIP is an application layer protocol that uses text format messages to setup, manage, and terminate multimedia communication sessions. SIP is a simplified version of the ITU H.323 packet multimedia system. SIP is defined in RFC 2543.

The called terminal may display the calling party enhanced information using the current technology for displaying current calling party information. Calling party enhanced information may be displayed in a variety of formats, such as visual and/or audio.

The present apparatus in one example may comprise a plurality of components such as one or more of electronic components, hardware components, and computer software components. A number of such components may be combined or divided in the apparatus.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. A system, comprising:
a calling terminal and a called terminal in a telecommunication system;
at least one of a specified name or a preferred call back number that are input at the calling terminal before originating a call to the called terminal;
at least one telecommunication system that operatively couples the calling terminal to the called terminal; and
the specified name and/or the preferred call back number being calling party information at the called terminal for the call from the calling party.

2. The system according to claim 1, wherein the calling terminal is one of a personal computer, a subscriber telephone, a pay telephone, a VoIP (voice over internet protocol) phone, or a mobile terminal, and wherein the called terminal is one of a personal computer, a subscriber telephone, a pay telephone, a VoIP phone, or a mobile terminal.

3. The system according to claim 1, wherein the telecommunication system comprise at least one of a PTSN (public switched telephone network) network, a data network, or a cellular network.

4. The system according to claim 3, wherein the data network is the Internet.

5. The system according to claim 1, wherein the system further includes a calling card feature in which at least one of a specified name or a preferred call back number is provided to the telecommunication system when the calling card is activated.

6. The system according to claim 5, wherein the at least one of a specified name or a preferred call back number, which are provided to the telecommunication system when the calling card is activated, are overrideable at the calling terminal with a new at least one of a specified name or a preferred call back number, before originating a call to the called terminal.

7. The system according to claim 1, wherein the call is a VoIP call.

8. A system, comprising:
a calling terminal that originates a VoIP (voice over internet protocol) call to a called terminal in a telecommunication system;
at least one of a specified name or a preferred call back number that are input at the calling terminal before originating the VoIP call to the called terminal;
the at least one telecommunication system operatively coupling the calling terminal to the called terminal, the telecommunication system having a data network and at least one of a PTSN (public switched telephone network) network or a cellular network; and
the specified name and/or the preferred call back number being calling party information at the called terminal for the VoIP call from the calling party.

9. The system according to claim 8, wherein the calling terminal is one of a personal computer, a subscriber telephone, a pay telephone, a VoIP phone, or a mobile terminal, and wherein the called terminal is one of a personal computer, a subscriber telephone, a pay telephone, a VoIP phone, or a mobile terminal.

10. The system according to claim 8, wherein the data network is the Internet.

11. The system according to claim 8, wherein the system further includes a calling card feature in which at least one of a specified name or a preferred call back number is provided to the telecommunication system when the calling card is activated.

12. The system according to claim 11, wherein the at least one of a specified name or a preferred call back number, which are provided to the telecommunication system when the calling card is activated, are overrideable at the calling terminal with a new at least one of a specified name or a preferred call back number, before originating a call to the called terminal.

13. The system according to claim 8, wherein the call is a VoIP call.

14. A method, comprising:
specifying, at a calling terminal, at least one of a caller name or a preferred call back number before originating a call to a called terminal in a telecommunication system;
originating the call and routing the call to the called terminal; and
providing the name and preferred call back number as calling party information at the called terminal.

15. The method according to claim 14, wherein the calling terminal is one of a personal computer, a subscriber telephone, a pay telephone, a VoIP (voice over internet protocol) phone, or a mobile terminal, and wherein the called terminal is one of a personal computer, a subscriber telephone, a pay telephone, a VoIP phone, or a mobile terminal.

16. The method according to claim 14, wherein the telecommunication system comprise at least one of a PTSN (public switched telephone network) network, a data network, or a cellular network.

17. The method according to claim 16, wherein the data network is the Internet.

18. The method according to claim 14, wherein the telecommunication system further includes a calling card feature in which at least one of a specified name or a preferred call back number is provided to the telecommunication system when the calling card is activated.

19. The method according to claim 18, wherein the at least one of a specified name or a preferred call back number, which are provided to the telecommunication system when the calling card is activated, are overrideable at the calling terminal with at least one of a new specified name or a new preferred call back number, before originating a call to the called terminal.

20. The method according to claim 14, wherein the call is a VoIP call.

21. A method, comprising:
specifying, before originating a call to a called terminal in a telecommunication system, at least one of a specified caller name or a preferred call back number that is different than a default call back number for a calling terminal; and
providing the specified caller name and preferred call back number as calling party information at a called terminal.

22. The method according to claim 21, wherein: for calling cards, a specified caller name and preferred call back number are specified when the calling card is activated; for calls placed through a public call office, PSTN (public switched telephone network) phones having an optional feature to input a specified caller name and call back number before the call is originated; for calls placed through a public call office, public PSTN phones having an optional feature to input a specified caller name and preferred call back number before the call is originated; and for public call office PC-to-PSTN calls a PC (personal computer) client capturing a specified caller name and preferred call back number before the call is originated; and for calls placed through a residential VoIP phone providing, as part of a service activation, a specified caller name and a preferred call back number.

23. The method according to claim 21, wherein: the calling terminal is one of a personal computer, a subscriber telephone, a pay telephone, a VoIP (voice over internet protocol) phone, or a mobile terminal, and wherein the called terminal is one of a personal computer, a subscriber telephone, a pay telephone, a VoIP phone, or a mobile terminal; and wherein the telecommunication system comprise at least one of a PTSN network, the Internet, or a cellular network.

24. The method according to claim 21, wherein the telecommunication system further includes a calling card feature in which at least one of a specified name or a preferred call back number is provided to the telecommunication system when the calling card is activated.

25. The method according to claim 21, wherein the call is a VoIP call.
